(19) United States
(12) Patent Application Publication
(10) Pub. No.: US 2007/0290532 A1
(43) Pub. Date: Dec. 20, 2007

(54) Combined Sensor and Heating Element

(75) Inventor: Thorsten Frank, Heidelberg (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 10/582,243

(22) PCT Filed: Oct. 23, 2004
(86) PCT No.: PCT/EP04/12010

§ 371 Date: Apr. 26, 2007

(30) Foreign Application Priority Data
Dec. 12, 2003 (DE) 103 58 791.8

(51) Int. Cl. B60N 2/56

(52) U.S. Cl. 297/180.12; 297/180.1

(57) ABSTRACT

The invention relates to a combined sensor and heating element (1) which is particularly suitable for a motor vehicle seal. Said sensor and heating element comprises a sensor mat which comprises a carrier film (2) and a cover film (3), sensors (6) which are arranged between the carrier film (2) and the cover film (3), and sensor conductor paths, in addition to a heating conductor arrangement. According to the invention, the conductor paths (4) of the heating conductor arrangement are integrated into the sensor mat.

### TECHNICAL FIELD

The present invention relates to a combined sensor and heating element, which is particularly suitable for a motor vehicle seat, comprising a sensor mat which comprises a carrier film and a cover film and sensors as well as sensor conductor paths arranged between the carrier film and the cover film, as well as a heating conductor arrangement.

### STATE OF THE ART

A combined sensor and heating element of the kind described above is known from LU 90 583 A1. The known combined sensor and heating element relates to the combination of so-called seat occupancy sensors, which are typically used to prevent the release of an airbag assigned to a specific seat during an accident, should the corresponding seat not be occupied, along with a seat heater. The seat occupancy sensors described in the document comprise a sensor mat with a carrier foil and a cover film and sensors and sensor conductor paths provided between the carrier foil and cover film, with the sensor mat comprising several pressure-sensitive areas, linked to each other by means of flexible connecting strips, formed by the cover film. According to the document the sensor mat is arranged on top of the motor vehicle seat in such way that the pressure-sensitive areas are distributed across the sitting area of the seat.

In general, a seat heater of a motor vehicle comprises a heating mat with two non-woven material layers and a heating element embedded between the two non-woven material layers. Such a heating mat is arranged on the sitting area of the motor vehicle seat such that the heating conductor is substantially distributed across the overall sitting area of the vehicle seat.

For vehicle seats equipped with a seat occupancy sensor as well as a seat heater, the sensor mat and heater mat assembled into a combined sensor and heating element prior to the seat installation. However, the manufacture of such a combined sensor and heating element is relatively complex, as the two functional elements have to be manufactured separately first and subsequently have to be fixated on top of each other.

Therefore LU 90 583 A1 proposes not to embed the heating conductors separately into a manageable non-woven laminate, which then has to be fixated on the sensor mat, but to apply it directly on the flexible connecting strips, meaning on the cover film, of the sensor mat. The production of such a combined sensor and heating element should therefore require considerably fewer individual steps than the manufacture of conventional combination elements. In addition, the material required for a such combined sensor and heating element should be considerably less than is the case with conventional functional elements.

### PRESENTATION OF THE INVENTION

It is the object of the invention to advance the development of a commonly known combined sensor and heating element in such a way that manufacturing is more simplified and the material requirements are further reduced. This object is achieved by means of a combined sensor and heating element with all the characteristics according to claim 1. A vehicle seat comprising a combined sensor and heating element according to the invention is described in claim 21. Claims 14 and 15 relate to methods for manufacturing a sensor and heating element according to the invention. Preferred embodiments of the invention are described in the dependent claims.

According to the invention, in a combined sensor and heating element, which is particularly suitable for a motor vehicle seat and comprises a sensor mat with a carrier film and a cover film as well as sensors and sensor conductor paths arranged between the carrier film and cover film as well as a heating conductor arrangement, it is provided that the conductor paths of the heating conductor arrangement are integrated into the sensor mat. The conductor paths of the heating conductor arrangement and the sensor conductor paths may be arranged on the inside of the carrier film as well as on the inside of the cover film. In particular, the conductor paths of the sensor arrangement and heating conductor arrangement may be applied next to each other on the same inner surface, either without intersecting points or with crossings, wherein in these areas insulation must be provided, for example by means of an applied insulation varnish or an insulation film.

In comparison to known combination elements, the combined sensor and heating element according to the invention is therefore characterized by its significantly simplified design. The two functional elements sensors and heater are not separately arranged in different functional areas as in known combination elements, but instead are joined in a combined sensor and heating mat. Contrary to known combination elements, considerably simpler manufacturing is possible as the conductor paths of the sensor arrangement and those of the heater may be applied simultaneously in one operation. In addition, material savings apply, for example because only one single cover film and/or protective layer is required. Reducing the number of process steps has the additional positive effect that also the risk of process errors is reduced. In total this leads to improved quality. The combination element according to the invention can therefore be manufactured in a simple and cost-effective way. In particular, known processes for manufacturing a combination element according to the invention may be used, as is described hereinafter.

It is obvious that also the wiring of the combined sensor and heating element to the outside, for example, to the analysis and/or supply electronics, may be integrated into the conductor path arrangement between the carrier and cover films. An simplifies the process further.

Preferably the conductor paths on the inside of the carrier film and the conductor paths on the inside of the cover film are electrically insulated against each other by means of an insulation film and/or insulation varnish that is applied between the carrier and cover films. The insulation film and/or insulation varnish may be designed as a spacer, in particular in the area of pressure-sensitive sensors or switches, such as film switches, between the carrier and cover films.

In another preferred embodiment of the invention, the sensor arrangement comprises seat occupancy sensors. In a broadest sense, all sensor types capable of creating a signal when the seat is occupied by a person are to be understood as seat occupancy sensors. A well-known group of seat occupancy sensors are pressure sensors, for example. Pressure sensors themselves are well-known and described multiple times in literature. Their mode of operation is based substantially on the change of electrical properties as a result of the weight that is applied on the sensor. This may be, for example, the production of an electrically conductive connection by means of pressure application on the sensor, but also the modification of electrical capacity with a change of distance by means of pressure application. In the scope of the present invention, simple seat occupancy sensors, which can only differentiate between the states “occupied” and “not occupied”, may be used, as well as sensors, which are suitable for recording and/or analyzing a pressure profile.

In another preferred embodiment of the invention, the output signal of the seat occupancy sensors is used for switching and/or controlling the heating conductor arrangement. This embodiment is particularly suitable for producing a seat heater with variable heated area, in which the heated area is divided into different zones, which may be switched and controlled independently from each other. Thus it may be provided, for example, that only those areas are heated, which are in direct body contact with the sitting occupant, while areas without contact are not heated. As there is large differences in regards to human body masses, the body contact areas are of different sizes as well, so that the heated areas vary for different people in order to achieve effective heating. The present invention therefore allows intelligent seat heating, wherein only the truly required areas are heated, resulting in considerable energy savings.

In addition to the simple variant of the simple on and off switching functions as the seat areas are occupied and/or not occupied, it is further possible within the scope of the present invention to set pre-determined heat profiles, which increase the well-being of a person located on the seat in such way that certain body areas are heated strongly, lightly or not at all where applicable with a time variance function.

However, as is known from the state of the art, the output signal of the seat occupancy sensors may be used additionally for airbag control.

In a simplified way, the present invention also allows the integration of switches, which may be operated by a person located inside the vehicle. These may be located, for example, on the side of the vehicle seat in form of operating panels. Suitable to function as switches are, for example, all seat occupancy sensors that have an additional switch function in addition to the seat occupation function. These may be applied easily in one operation on the carrier film.

Preferably so-called membrane switches are used as pressure sensors, such as dome switches. Membrane switches themselves are commonly known. Usually they consist of an electrode pair that is disposed on the carrier film, above which a contact area may be provided, for example designed as a dome and made of plastic, particularly polyester or also metal. The contact areas and/or domes may be connected to one of the two electrodes in an electrically conductive manner. With contact areas and/or domes made from non-conductive material, such as polyester, electrically conductive connecting elements may also be provided in the region of the contact area and/or the dome, which elements upon actuation by the contact area and/or dome establish the electrical contact. The confirmation is carried out by means of pressurization. The contact area and/or dome or the circuit on the contact area or the dome arches inward and establishes the contact to the second electrode and/or between the two electrodes to be connected. Membrane switches therefore are characterized by a relatively simple design and may also be manufactured in a cost-efficient way. However, it is also possible to use so-called “flat switches” as those described in LU 90 583 A1. It is obvious that the electrode pairs of these sensors are part of the sensor conductor paths and therefore are manufactured with them in the same operation.

Instead of the seat occupancy sensors, a sensor arrangement comprising temperature sensors may be provided. A combination of seat occupancy sensors and temperature sensors is possible as well.

Preferably, the conductor paths are made of copper or also of silver or carbon, produced by conductive pastes. Advantageously, the same material is used for the heating conductor and sensor arrangements. However, it is also feasible that the conductor paths for the heating conductor and sensor arrangements are made of different materials. The use of the same material for both functional elements has the advantage of simplified producibility.

The carrier film and/or cover film usually comprise a flexible plastic film, for example made of PI (polyimide), PEN (polyethylene naphthalate) or PET (polyethylene terephthalate).

The design of a combined sensor and heating element is also significantly simplified in that the electrical connections of the heating conductor and sensor arrangements are arranged on the carrier film in such way that they can be connected to the same connector plug. It is particularly advantageous if the heating conductor and sensor arrangements can be connected to common analysis and supply electronics.

In another preferred embodiment of the invention, switches, diodes and/or electronics components may be integrated into the combined sensor and heating element.

A combined sensor and heating element according to the invention is particularly suitable for use with seats in a motor vehicle, wherein in the simplest case only one heating zone may be provided. An intelligent seat heater with a variable heating area requires the heating conductor and corresponding sensors on the sitting area and/or seat back of the vehicle seat to be arranged in such way that they form heating zones that can be switched and controlled independently from each other. Particularly efficient heating of a vehicle seat is achieved in that the heating zones are adapted to the contour of a human body occupying the seat.

However, the combined sensor and heating element according to the invention is not limited to the above-mentioned application. In particular, the possibility of separation it into independently switchable and controllable zones, the geometric designs of which may be adapted in a simple way to the respective application, opens up a plurality of applications.

A combined sensor and heating element according to the invention is preferably manufactured with one of the following processes:

In a first step, a coat of a conductor path material is applied to the inside of the carrier film and/or the inside of the cover film (hereinafter also referred to as carrier). Preferably, the conductor path material, which is preferably made of copper, is laminated onto the carrier. Subsequently an etch-resistant coating is imprinted on the conductor path coating. Where applicable, cleaning and etching of the conductor path coating may precede this step. The etch resist is applied in a pattern that matches the desired conductive pattern. According to a preferred embodiment of the invention, the conductive pattern may also comprise the wiring of the combined sensor and heating element to the outside, for example to the analysis and supply electronics units. In the subsequent etching process, the conductor path coating is etched off the areas not covered by the etch resist down to the flexible carrier film. The etching process is preferably conducted in an acid solution. Here, for example, hydrochloric acid (HCl), hydrogen peroxide (H₂O₂) or a copper chloride (CuCl₂) solution are suitable. After removing the resist by rinsing it with an alkaline dilution, the so-called stripping, the finished conductor path structure is present on the carrier film and/or cover film. In a further step, the protective layer, for example made of one or more plastic films and/or non-woven layers, may be applied, preferably by lamination.

Another method for manufacturing the conductor path structure is a conductive paste application, for example silver or carbon application. If such method is used, the etching and stripping processes become obsolete. However, coating and edging processes as described above and conductive paste application may also be used together.

The described methods are well-known and tested methods for manufacturing printed circuits. These well-known methods allow the particularly easy and cost-effective production of a combined sensor and heating element according to the invention. Particularly the production of the conductor paths for the heating conductor and sensor arrangements in just one operation results in a significantly simpler process compared to the generally known combination elements.

### BRIEF DESCRIPTION OF THE DRAWING

The invention will be described in more detail hereinafter with reference to the figures, wherein:

FIG. 1 is a preferred embodiment of a combined sensor and heating element according to the invention

FIG. 2 is a flow-chart of the most important process steps of a preferred method for manufacturing a sensor and heating element.

### IMPLEMENTATION OF THE INVENTION

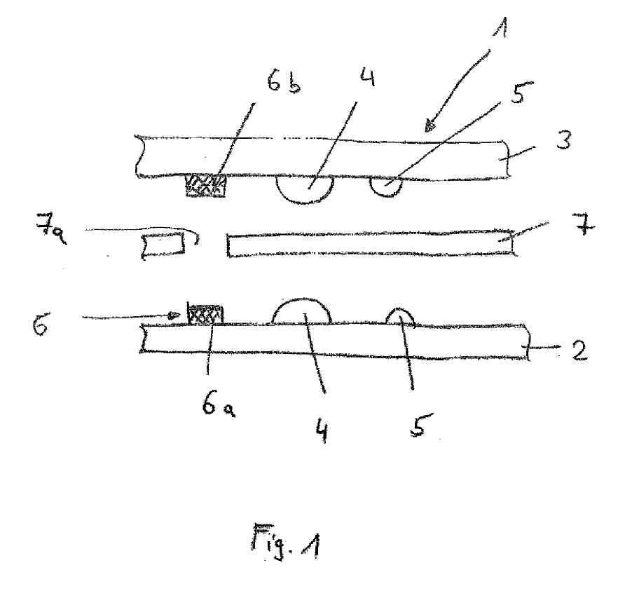

In FIG. 1, a combined sensor and heating element according to the invention is shown. This combined sensor and heating element comprises a flexible carrier film 2 as well as a flexible cover film 3. On the carrier film 2 as well as on the cover film 3 heating conductors 4 and wiring conductor paths 5 are applied. Furthermore, on both films the contact electrodes 6a, 6b of a pressure sensitive sensor 6 can be seen. The sensor conductor paths leading to the sensor electrodes 6a, 6b are located on the carrier film 2 and/or cover film 3 as well, however they are not shown in the figure for better clarity. A separating film 7 with a perforation 7a in the area of pressure sensor 6 provides the electrical insulation of the conductor paths 4 and 5 as well as of the sensor conductor paths against each other on the carrier film and the cover film, and furthermore represents a spacer between carrier film 2 and the cover film 3, particularly in the region of the pressure-sensitive sensor 6.

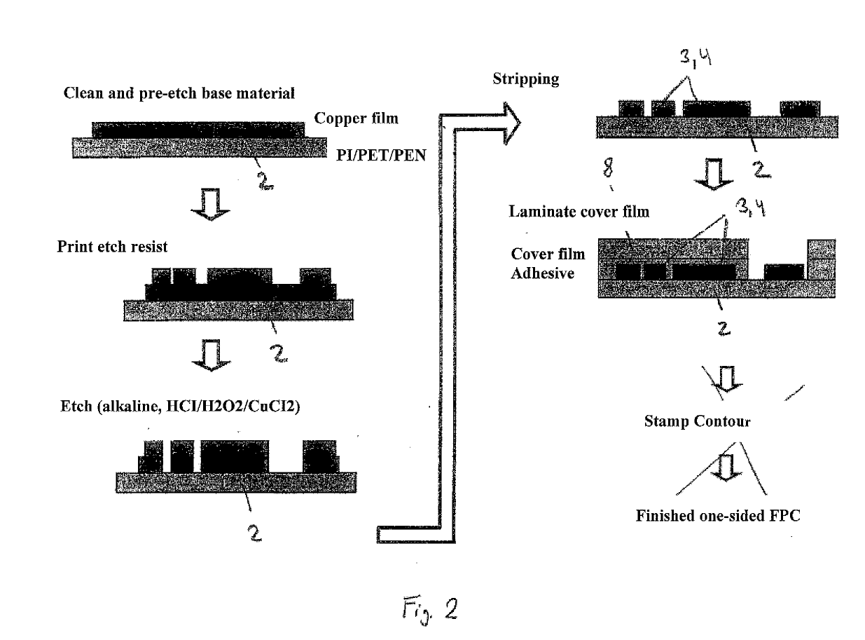

In FIG. 2, the most important steps of a preferred method for manufacturing a combined sensor and heating element (1) according to the invention are illustrated. In a first step, the flexible carrier film and/or cover film 2, 3, for example made of PI (polyimide), PET (polyethylene terephthalate), PEN (polyethylene naphthalate), are covered with a conductor path material, for example a copper film. It is preferred if the copper film is laminated onto the flexible carrier material.

Subsequently, the base material manufactured this way is cleaned and etched. In a subsequent step, the etch resist is applied in a pattern matching the desired conductor pattern. In the subsequent etching process, the conductor path material is etched away in the areas not coated with the etch resist down to the carrier film 2 and/or cover film 3 by means of an acid solution. Following the removal of the etch resist by means of stripping, meaning by rinsing with an alkaline solution, the finished conductor pattern of the conductor path material remains on the carrier film and/or cover film. For protection of the conductor path structure, a protective layer 8, for example made of plastic film or non-woven material, may be applied, preferably by lamination.

1. A combined sensor and heating element, which is particularly suitable for a motor vehicle seat, comprising a sensor mat which comprises a carrier film and a cover film and sensors and sensor conductor paths arranged between the carrier and cover film, as well as a heating conductor arrangement, characterized in that the conductor paths (4) of heating conductor arrangement are integrated in the sensor mat.

2. A combined sensor and heating element according to claim 1, characterized in that conductor paths (4) of the heating conductor arrangement and/or the sensors (6) and/or sensor conductor paths are arranged on the inside of carrier film (2) and/or of the cover film (3).

3. A combined sensor and heating element according to claim 2, characterized in that the conducting paths on the inside of the carrier film (2) and those on the inside of the cover film (3) are electrically insulated against each other by means of an insulation film and/or insulation varnish (7).

4. A combined sensor and heating element according to claim 3, characterized in that the insulation film and/or insulation varnish (7) are designed as spacers between the carrier film (2) and the cover film (3).

5. A combined sensor and heating element according to any one of the claims 1 to 4, characterized in that the sensor arrangement comprises seat occupancy sensors and/or temperature sensors.

6. A combined sensor and heating element according to claim 5, characterized in that the heating conductor arrangement can be switched and/or controlled by means of seat occupancy sensors.

7. A combined sensor and heating element according to claim 5 or 6, characterized in that the signal of the seat occupancy sensors can be used for airbag control.

8. A combined sensor and heating element according to any one of the claims 1 to 7, characterized in that the seat occupancy sensors comprise pressure sensors.

9. A combined sensor and heating element according to claim 8, characterized in that the pressure sensors comprise so-called membrane switches.

10. A combined sensor and heating element according to any one of the claims 1 to 9, characterized in that the conductor paths (4) for the heating conductor and sensor arrangements are made from the same material.

11. A combined sensor and heating element according to any one of the claims 1 to 10, characterized in that the conductor paths (4) for the heating conductor and sensor arrangements are made of Cu and/or conductive paste.

12. A combined sensor and heating element according to any one of the claims 1 to 11, characterized in that the carrier film (2) and/or the cover film (3) comprise a flexible plastic film.

13. A combined sensor and heating element according to claim 12, characterized in that the plastic film is made of PI (polyimide), PET (polyethylene terephthalate) and/or PEN (polyethylene naphthalate).

14. A combined sensor and heating element according to any one of the claims 1 to 13, characterized in that the electrical connectors of the heating conductor and sensor arrangements are arranged on the carrier film (2) and/or cover film (3) such that they can be connected to the same connector plug.

15. A combined sensor and heating element according to any one of the claims 1 to 14, characterized in that the heating conductor and sensor arrangements can be connected to joint analysis and supply electronics units.

16. A combined sensor and heating element according to any one of the claims 1 to 15, characterized in that it comprises wiring (5) to the analysis and supply electronics units.

17. A combined sensor and heating element according to any one of the claims 1 to 6, characterized in that diodes, switches and/or electronics components are integrated.

18. A combined sensor and heating element according to any one of the claims 1 to 17, characterized in that the sensor and heating elements are separated into zones, which can be switched and controlled independently from each other.

19. A vehicle seat, comprising at least one combined sensor and heating element according to any one of the claims to 18.

20. A vehicle seat according to claim 19, characterized in that on the sitting area and/or seat back of the vehicle seat heating zones are provided, which can be switched and controlled or adjusted independently from each other.

21. A vehicle seat according to claim 20, characterized in that the heating zones are adjusted to the contour of a human body occupying the seat.

22. A method for manufacturing a combined sensor and heating element according to any one of the claims 1 to 21, characterized in that the conductor path structure and/or wiring is at least partially applied by means of a conductive paste application process.

23. A method for manufacturing a combined sensor and heating element according to any one of the claims 1 to 22, characterized in that the conductor path structure and/or wiring are applied at least partially by means of one of the following steps:
a) application of a coating made from conductor path material on the carrier film and/or cover film,
b) application of etch resist in a pattern, which matches the desired conductor pattern, on the coating made from the conductor path material,
c) etching away of the conductor path material in the non-coated areas, removal of the etch resist coating.
